(19) United States
(12) Patent Application Publication
(10) Pub. No.: US 2007/0001460 A1
(43) Pub. Date: Jan. 4, 2007

(54) Method and system for power generation

(75) Inventor: Daniel J. Killian, Pompano Beach, FL (US)

Correspondence Address: KING & SPALDING LLP, 1180 PEACHTREE STREET, ATLANTA, GA, 30309, US

(73) Assignee: Energy & Engine Technology Corporation, Plano, TX (US)

(21) Appl. No.: 11/159,576

(22) Filed: Jun. 23, 2005

Related U.S. Application Data
(60) Provisional application No. 60/582,314, filed on Jun. 23, 2004.

(51) Int. Cl. F03D 9/00; H02P 9/04

(52) U.S. Cl. 290/44

(57) ABSTRACT

A magneto-turbine power generating system allows for the clean, efficient generation of excess electrical power on a small or large scale. The magneto-turbine power generating system is a self-contained system that generates power greatly in excess of the system's needs, thereby allowing the system to act as an energy source for other products requiring electrical energy. A flywheel combining magnetic and turbine power generating capabilities allows for a clean source of reusable energy. The use of a magneto flywheel provides an electrical generating system capable of starting without need of an extrinsic electrical source. Once the magneto flywheel generates a low-level of electrical power, the turbine system is powered to increase the power generation capabilities of the system.

### STATEMENT OF RELATED PATENT APPLICATION

This non-provisional patent application claims priority under 35 U.S.C. §119 to U.S. Provisional Patent Application No. 60/582,314, titled Power Generator, filed Jun. 23, 2004. The provisional application is hereby fully incorporated herein by reference.

### FIELD OF THE INVENTION

The present invention relates to the field of power generation. More particularly, the present invention relates to a system comprising a flywheel magneto generator having turbine fan blades for increased power generation.

### BACKGROUND OF THE INVENTION

As the world's population expands and its economy increases, increased use of fossil fuels has raised atmospheric concentrations of carbon dioxide, threatening habitats and causing climate changes. Even with improvements in efficiency and environmental protection, some experts say that atmospheric levels of carbon dioxide may be double that of the pre-industrial era by the end of the twenty-first century. While fossil fuels are the basis for many nations′ economies, fossil fuels are a non-renewable resource that will, at some point, become harder and harder to obtain.

In an effort to discover sources of renewable energy, a great deal of research has been conducted into ways of generating electricity using wind, water, and solar power. While wind, water, and solar power have found limited application in specific areas of the world, none of these provides a cost-efficient power source in all areas of the U.S., much less the world. In order to produce cost-efficient energy using wind-generated electricity, a consistent wind at speeds that can only be found in portions of California and certain parts of the Midwest is required. Hydro-electric power is only cost efficient in areas where large dams and sufficient water-sources are currently in place. Solar power cells have never been able to generate enough energy to reach the efficiency or scale many had hoped.

Automobiles are another source of carbon monoxide and carbon dioxide levels in our atmosphere. Some of the largest polluters are commercial vehicles operating diesel engines. In an effort to reduce pollution caused by some of these commercial vehicles, some states are instituting laws restricting the ability of commercial vehicles to idle for hours at truck-stops and rest areas. Absent having a power substation next door, most truck-stops are not able to provide sufficient power to the commercial vehicles in order to allow drivers to get the legislated amount of rest in their vehicles, while keeping the vehicle powered at the truck or rest stops.

In view of the foregoing, there is a need for a system of generating electrical power on both a small and large scale. There is a need for a power generating system that is not dependent on fossil fuels, sustainable winds, abundant water sources, or solar technology. There is also a need for a power generating system based on a power source that is constant, renewable, and reusable.

### SUMMARY OF THE INVENTION

The present invention overcomes the problems of fossil-fuel use and the deficiencies of other renewable energy sources by providing a self contained power generating system that combines the power generating capabilities of a magneto flywheel and a turbine system. The magneto flywheel generates an initial level of electricity, capable of starting one or more blowers that can be used to generate high-velocity air pressure. The high velocity air pressure can be directed at a series of turbine fan blades, increasing the power generating levels of the system by increasing the rate at which a shaft of an alternator is turned. The alternator can then provide enough energy not only for the system but can also act as an energy source for external power systems. Because the source of electricity is magnets and air, the source of the electricity is clean, re-usable and is of an unlimited supply.

For one aspect of the present invention, a horsepower accelerator wheel can be attached to a drive shaft. The horsepower accelerator wheel can comprise multiple magnets along the circumference of the wheel and multiple turbine fan blades along the outside of the wheel, running from the circumference of the wheel towards the center-point of the wheel. The drive shaft can be attached to a motor, acting as a load balancer, and an alternator, which generates energy based on the speed of rotation of the drive shaft. A series of blowers can be positioned to provide high velocity air against the turbine fan blades and large stationary magnets can be positioned adjacent to the magnets on the circumference of the wheel to initiate the rotation of the wheel and the initial generation of electricity.

Another aspect of the present invention comprises a method of generating electricity, wherein stationary magnets are positioned adjacent to the rotational magnets coupled to the horsepower accelerator wheel in such a way as to induce rotation of the wheel. The wheel drives a shaft coupled to an alternator that generates a first level of electricity. A portion of the first level of electricity can be transmitted to a first blower to generate high-velocity air against a first set of turbine fan blades coupled to the wheel. The operation of the first blower against the first set of turbine blades increases the rotational speed of the wheel, thereby generating a second level of electricity at the alternator that is greater than the first level. A portion of the second level of electricity can be transmitted to the first blower and a second blower, wherein the second blower generates high-velocity air against a second set of turbine fan blades coupled to the wheel. The operation of the first blower and the second blower against the turbine blades further increases the rotational speed of the wheel, thereby generating a third level of electricity at the alternator that is greater than the second level. A portion of the third level of electricity can then be transmitted to external electrical consumers.

### BRIEF DESCRIPTION OF DRAWINGS

For a more complete understanding of the present invention and the advantages thereof, reference is now made to the following description in conjunction with the accompanying drawings in that:

FIG. 1 depicts an angled view of an electrical power generation system in accordance with an exemplary embodiment of the present invention;

FIG. 2 depicts a frontal view of the electrical power generation system in accordance with an exemplary embodiment of the present invention; and

FIG. 3 depicts a section view of a horsepower accelerator wheel in accordance with an exemplary embodiment of the present invention.

### DETAILED DESCRIPTION OF THE EXEMPLARY EMBODIMENTS

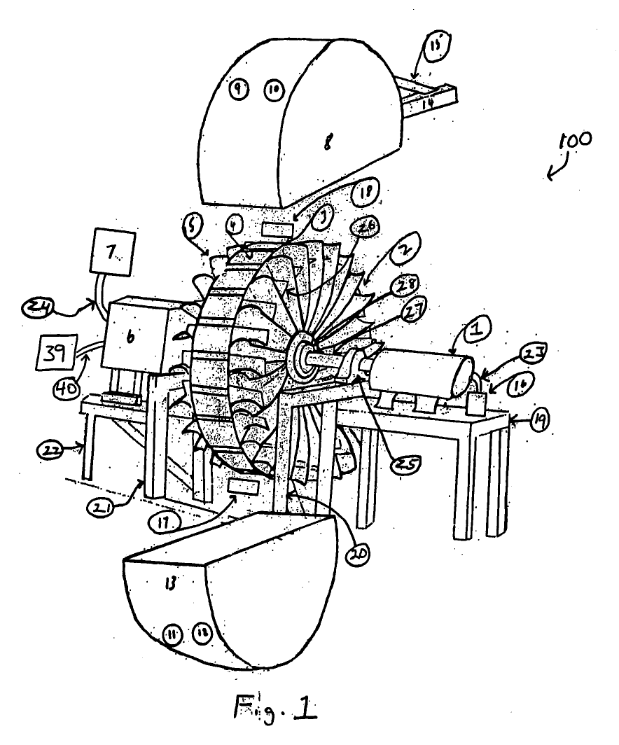

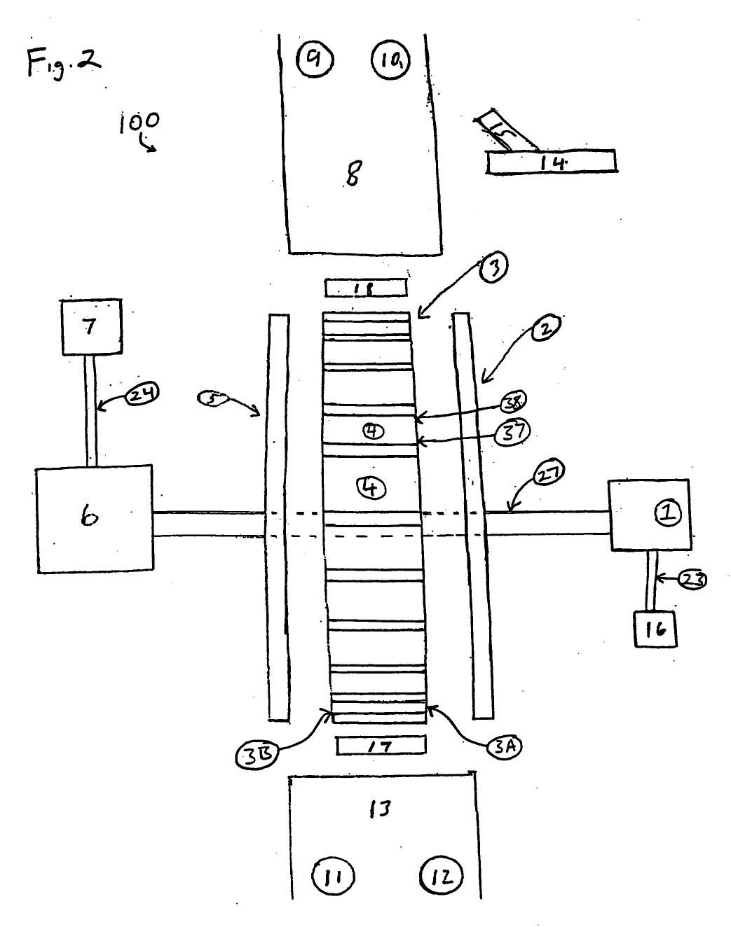

The present invention supports the generation of electrical power through the use of a horsepower accelerator wheel as can be more readily understood by reference to the representative system illustrated in FIGS. 1 and 2. FIG. 1 is a angled view of an electrical power generation system (“generator system”) 100, in accordance with an exemplary embodiment of the present invention. FIG. 2 is a frontal view of the generator system 100 in accordance with an exemplary embodiment of the present invention. The generator system 100 can include a motor 1 comprising a singe-phase or three-phase motor. The motor 1 can be designed to receive standard American (60 Hz.) or European (50 Hz.) electricity. The size of the motor 1 is generally determined based on the application or amount of power that must be generated by the system, however, any size motor 1 can be used. The motor 1 typically acts as a load balancer for the generator system 100. In one exemplary embodiment, the motor 1 is a 3 horsepower, 110 volt, 60 hertz motor.

The motor 1 can be attached to a mounting platform 19 with fasteners, such as nuts, bolts, or screws, or can be welded, riveted, or attached using any other attachment method known in the art (not shown). The mounting platform 19 can comprise a table or any other stationary surface that allows a drive shaft of the motor 1 (not shown) to be substantially parallel with a drive shaft 27. The motor drive shaft (not shown) can be attached to the drive shaft 27 with a coupling, welding, or other attachment methods known in the art (not shown). In one exemplary embodiment, the motor drive shaft (not shown) is attached to the drive shaft 27 using a spider coupling (not shown). In another exemplary embodiment, the motor 1 can be directly attached to a horsepower accelerator wheel 3 with a coupling (not shown) or other attachment method known in the art.

The drive shaft 27 typically comprises a solid cylindrical shaft that is attached to the motor 1, horsepower accelerator wheel 3 and an alternator 6. The drive shaft 27 can comprise a metal, alloy, plastic, or other element having characteristics of high strength and durability. In one exemplary embodiment, the drive shaft 27 comprises a hardened stainless steel shaft. The diameter of the drive shaft 27 is typically based on the size of the horsepower accelerator wheel 3 and the application the generator system 100 is being used to power. The length of the drive shaft 27 is typically dependent on the distance between the motor 1 and the alternator 6. In situations where the drive shaft length between the motor 1 and the horsepower accelerator wheel 3 is more than insubstantial, the drive shaft 27 can pass through a pillow block bearing 25 placed between the motor 1 and the horsepower accelerator wheel 3. The pillow block bearing 25 can be attached to a mounting bracket 20 with fasteners, such as nuts, bolts, or screws, or can be welded, riveted, or attached using any other attachment method known in the art (not shown). The mounting bracket 20 can comprise two pieces of steel square tubing, running in the vertical direction attached orthogonally to a horizontal piece of steel square tubing at the top of the two vertical pieces. The vertical and horizontal pieces of the mounting bracket 20 can be attached to one another with fasteners, such as nuts, bolts, or screws, or can be welded, riveted, or attached using any other attachment method known in the art (not shown).

The drive shaft 27 is typically attached orthogonally to and passes through the center-point of the horsepower accelerator wheel 3 in such way that the horsepower accelerator wheel 3 will rotate about the axis of the drive shaft 27. The drive shaft 27 can be attached to the horsepower accelerator wheel 3 with fasteners, such as nuts, bolts, or screws, or can be welded, riveted, or attached using any other attachment method known in the art (not shown). In one exemplary embodiment, a metal sleeve 28 is welded to the drive shaft 27. The drive shaft 27 and metal sleeve 28 are then slid into and through the horsepower accelerator wheel 3 and the metal sleeve 28 is welded to the horsepower accelerator wheel 3 to provide the axis of rotation.

As shown in FIGS. 1 and 2, the horsepower accelerator wheel 3 can comprise a right-side wheel plate 3A, a left-side wheel plate 3B, multiple right-side turbine fan blades 2 (“right-side blades”), multiple left-side turbine fan blades 5 (left-side blades”), multiple gussets 26, and multiple rotational magnets 4. The overall radius of the horsepower accelerator wheel 3 is typically based on the load level of the alternator 6 and the amount of power to be generated. The right-side wheel plate 3A and the left-side wheel plate 3B can each comprise a flat, circular, metallic plate having a circular hole bored at the center-point of the plate for accepting the drive shaft 27 and the sleeve 28. In one exemplary embodiment, the right-side wheel plate 3A and the left-side wheel plate 3B comprise 3/16 inch solid steel plate, however other metal, alloys or plastics could be used in creating wheel plates 3A and 3B.

Multiple magnet mounts 29 are attached orthogonally between and along the circumference of wheel plates 3A and 3B. In one exemplary embodiment, the magnet mounts 29 are made of angle iron and faced together in pairs to create a U-shaped cavity just below the circumference of the horsepower accelerator wheel 3 so that when a rotational magnet 4 is placed into the cavity created by the mounts 29, the top of the rotational magnet 4 is substantially equal with the circumference of the horsepower accelerator wheel 3. Each magnet mount 29 can be attached to wheel plates 3A and 3B with fasteners, such as nuts, bolts, or screws, or can be welded, riveted, or attached using any other attachment method known in the art (not shown).

Multiple rotational magnets 4 are attached to the magnet mounts 29 with fasteners, such as nuts, bolts, or screws (not shown). In one exemplary embodiment, the rotational magnets 4 are attached to a stainless steel plate (not shown) on the side of the magnet 4 facing towards the center-point of the wheel 3. The stainless steel plate is then bolted to the magnet mounts 29. The rotational magnets 4 are placed along the circumference of the horsepower accelerator wheel 3 and spaced substantially equidistant from one another. The length of the rotational magnet 4 is typically greater than its width, with the length being considered the direction parallel to the drive shaft 27. Each rotational magnet 4 typically comprises a leading edge 38 having a polarity that is opposite from the trailing edge 37 of the rotational magnet 4, with the leading edge 38 comprising the edge of the rotational magnet 4 that passes a point first based on rotation of the wheel 3. In one exemplary embodiment, the rotational magnet 4 has a leading edge 38 having a south polarity and a trailing edge 37 having a north polarity. The rotational magnet 4 can be comprised of ceramic, an earth magnet, an electromagnet, or any other type of magnet known in the art. In one exemplary embodiment the rotational magnets 4 comprise earth magnets made of load stone based on their ability to hold a consistent magnetic permeability. The rotational magnets 4 can have a flat surface or be machined to have a curvature substantially equal to the circumference of the horsepower accelerator wheel 3. In one exemplary embodiment, the distance between rotational magnets 4 is one inch, however, this distance can be greater or less based on the overall circumference of the horsepower accelerator wheel 3 and the strength of the rotational magnets 4 and/or the stationary magnets 18.

As shown in FIG. 1, multiple right-side blades 2 are attached substantially orthogonally to the outside of wheel plate 3A. Multiple left-side blades 5 are attached substantially orthogonally to the outside of wheel plate 3B. The right-side blades 2 and the left-side blades 5 can be tapered in such a way that the blades 2 and 5 are wider at the circumference of the horsepower accelerator wheel 3 and get narrower as the blades 2 and 5 get closer to the hub or center-point of the horsepower accelerator wheel 3. The blades 2 and 5 can comprise any metal, alloy, plastic, or carbon-fiber element. In one exemplary embodiment, the blades 2 and 5 are comprised of sheet metal. The blades 2 and 5 are designed to operate much like the sail of a sailing ship by catching air generated by one or more blowers 9, 10, 11, and 12. In one exemplary embodiment, the blades 2 and 5 are cupped in the direction of the air flow to allow the blades 2 and 5 to catch more air and increase the speed of the horsepower accelerator wheel 3. The top of the blades 2 and 5 can be substantially equal to the circumference of the horsepower accelerator wheel 3, however, this is not necessary for proper operation of the generator system 100.

The blades 2 and 5 can be attached to the right-side wheel plate 3A and left-side wheel plate 3B with fasteners, such as nuts, bolts, or screws, or can be welded, riveted, or attached using any other attachment method known in the art (not shown). In one exemplary embodiment the blades 2 and 5 are each attached to a piece of sheet metal (not shown) that is substantially in the shape of the left-side 3B and right-side 3A wheel plates. The sheet metal piece can then be attached to the outer sides of the left-side 3B and right-side 3A wheel plates with fasteners, such as nuts, bolts, or screws, or can be welded, riveted, or attached using any other attachment method known in the art (not shown). In another exemplary embodiment, the right-side wheel plate 3A and the right-side blades 2 and the left-side wheel plate 3B and left-side blades 5 can comprise a single piece of metal, plastic, or other material created from a cast or mold. The space between each left-side blade 5 or right-side blade 2 typically depends on the total circumference of the horsepower accelerator wheel 3. The space between blades 2 or 5 should generally be enough to allow air generated by blowers 9, 10, 11, and 12 to compress itself. In one exemplary embodiment, the right-side blades 2 are three-inches apart and the left-side blades 5 are three-inches apart along the circumference of the horsepower accelerator wheel 3. The left-side blades 5 and the right-side blades 2 are typically positioned at the same points along the circumference of the horsepower accelerator wheel 3 so that there is substantially no offset, which could cause the horsepower accelerator wheel 3 to become imbalanced.

As shown in FIG. 1, a gusset 26 can be orthogonally attached between each right-side blade 2 and/or left side blade 5. The gusset 26 typically extends from the trailing edge of one blade 2 or 5 to the leading edge of the next blade 2 or 5. The gusset 26 also can extend from the outer-side of the right-side 3A or left-side 3B wheel plate to a point substantially equal with the outer edge of the tapered right-side blade 2 or left-side blade 5. The gusset 26 provides increased strength for the blades 2 and 5. The gusset 26 can also help to maintain air pressure on the blades 2 and 5. The gusset 26 can be attached to the blades 2 and 5 and/or the right-side 3A or left-side 3B wheel plate with fasteners, such as nuts, bolts, or screws, or can be welded, riveted, or attached using any other attachment method known in the art (not shown). The gusset 26 can be attached to the blades 2 and 5 at any point along the radius of the right-side 3A and left-side 3B wheel plates. The gusset 26 can comprise any metal, alloy, plastic, or carbon-fiber element. In one exemplary embodiment, the gusset 26 comprises sheet metal attached to the leading and trailing edge of the blades 2 or 5 with spot welds.

One or more covers 8 and 13 can be designed in such a way as to enclose the horsepower accelerator wheel 3, one or more stationary magnets 17 and 18, and one or more blowers 9, 10, 11, and 12. The covers 8 and 13 can be mounted to the mounting brackets 20 and 21 with fasteners, such as nuts, bolts, or screws, or can be welded, riveted, or attached using any other attachment method known in the art (not shown). Enclosing the horsepower accelerator wheel 3 with the covers 8 and 13 helps ensure that the only air pressure the blades 2 and 5 receive is from the blowers 9, 10, 11, and 12. The covers 8 and 13 typically comprise materials that have very low or no magnetic permeability, thereby limiting the affect of magnetic pull on objects outside of the covers 8 and 13. In one exemplary embodiment, the covers 8 and 13 comprise aluminum, however plastic, LEXAN, or other products known to one of ordinary skill in the art could be used. It should be noted that power generated by the generator system 100 is improved when the covers 8 and 13 are positioned as close to the horsepower accelerator wheel 3 as possible without making contact with and causing drag on the horsepower accelerator wheel 3. In one exemplary embodiment, the covers 8 and 13 comprise a two-piece design whereby each cover piece covers substantially half of the horsepower accelerator wheel 3. The two covers 8 and 13 can be attached together with fasteners, such as nuts, bolts, or screws, or can be welded, riveted, or attached using any other attachment method known in the art (not shown). Furthermore, a gasket (not shown) made of neoprene or other material can be placed between the two covers 8 and 13 to create an improved seal.

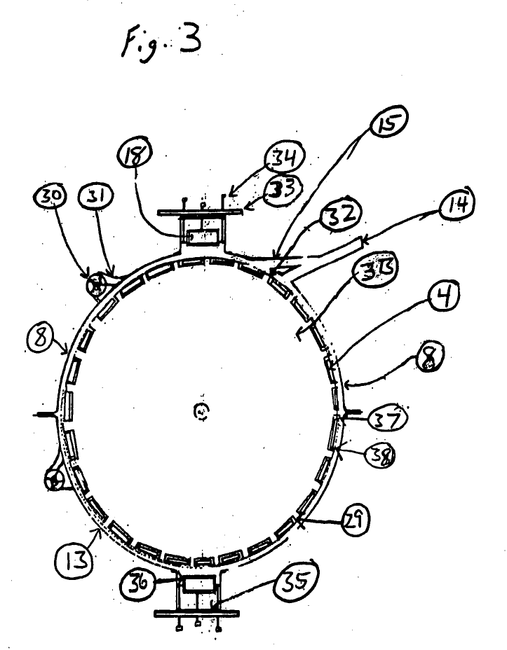

As shown in FIGS. 1 and 3, one or more blowers 9, 10, 11, and 12 can be mounted (not shown) inside of covers 8 or 13. The blowers 9, 10. 11, and 12 comprise a motor 30 and an output vent 31 (See FIG. 3). The blower motor 30 typically comprises an electrical motor capable of outputting air at a high velocity. The output vent 31 is typically designed to distribute the high velocity air along the width of the blades 2 and 5 at a point substantially equal to the circumference of the horsepower accelerator wheel 3, thereby generating the greatest amount of force against the blades 2 and 5 to cause the horsepower accelerator wheel 3 to rotate at the highest possible speed. The blower motor 30 is electrically coupled to a breaker box 7, which provides electrical power to the blower motor 30 for blowers 9, 10, 11, and 12. In one exemplary embodiment, the blowers 9, 10, 11, and 12 are 5000 rpm blowers operating at 110 volts. Furthermore, in the exemplary embodiment, four blowers can be used to generate air pressure against the blades 2 and 5. In this exemplary embodiment, two blowers 9 and 11 are positioned to provide air pressure against the left-side blades 5 and two blowers 10 and 12 are positioned to provide air pressure against the right-side blades 2.

As shown in FIGS. 1 and 3, one or more exhaust ports 14 can be attached to the covers 8 and 13. The exhaust port 14 is mounted in such a way as to generate a vacuum to pull and remove the air from the backside of the right-side blades 2 and left-side blades 5. By removing all or substantially all of the air from the backside of the blades 2 and 5, drag on the blades 2 and 5 is reduced. The number and positioning of exhaust ports 14 is typically determined by the application or use of the generator system 100 and the positioning of the blowers 9, 10, 11, and 12. The exhaust port 14 is typically the same width as the blades 2 and 5 at the circumference of the horsepower accelerator wheel 3. A hole the width of the exhaust port 14 and approximately one-inch in height can be made in the cover 8 or 13. The exhaust port 14 can be attached to the hole in the cover 8 or 13 with fasteners, such as nuts, bolts, or screws, or can be welded, riveted, or attached using any other attachment method known in the art (not shown). Further, a gasket (not shown) made of neoprene or other material can be placed between the cover 8 or 13 and the exhaust port 14.

As shown in FIGS. 1 and 3, the exhaust port 14 is typically located above the right-side 2 or left-side 5 blades in a position along the circumference of the horsepower accelerator wheel 3 between blowers 9 and 11 or 10 and 12 depending on which side of the cover the exhaust port is attached to. In one exemplary embodiment, an exhaust port 14 is attached to the cover after each blower 9, 10, 11, and 12 in the generator system 100. The exhaust port 14 is typically made of materials that very low or no magnetic permeability. In one exemplary embodiment, the exhaust port 14 comprises aluminum tubing extending orthogonally away from the cover 8 or 13. In another exemplary embodiment, the air pulled away from the blades 2 or 5 by the exhaust port 14 can be piped back inside the covers 8 and 13 and directed against the blades 2 and 5 to act substantially like a blower 9, 10, 11, and 12 using air piping that is well known in the art.

As shown in FIGS. 1 and 3, one or more exhaust system tubes 15 can be attached to the covers 8 and 13 on one end and the exhaust port 14 on the other. The exhaust system tube 15 typically comprises materials that have very low or no magnetic permeability. In one exemplary embodiment, the exhaust system tube 15 comprises aluminum tubing. The exhaust system tube 15 is typically the same width as the blades 2 and 5 at the circumference of the horsepower accelerator wheel 3. A hole the width of the exhaust system tube 15 and approximately one-inch in height can be made in the cover 8 or 13. The exhaust system tube 15 can be attached to the hole in the cover 8 or 13 with fasteners, such as nuts, bolts, or screws, or can be welded, riveted, or attached using any other attachment method known in the art (not shown). Further, a gasket (not shown) made of neoprene or other material can be placed between the cover 8 or 13 and the exhaust system tube 15. A hole the width of exhaust system tube 15 and approximately one-inch in height can also be made in the exhaust port 14. The exhaust system tube 15 can be attached to the hole in the exhaust port 14 with fasteners, such as nuts, bolts, or screws, or can be welded, riveted, or attached using any other attachment method known in the art (not shown). Furthermore, a gasket (not shown) made of neoprene or other material can be placed between the exhaust port 14 and the exhaust system tube 15 to create an improved seal and further reduce the amount of air escaping from the wheel 3.

The exhaust system tube 15 is typically located above the right-side 2 or left-side 5 blades in a position along the circumference of the horsepower accelerator wheel 3 between blowers 9 and 11 or 10 and 12 depending on which side of the cover the exhaust port is attached to. In the exemplary embodiment there is one exhaust tube 15 for each blower 9, 10, 11, and 12. The exhaust tube 15 is typically located before the exhaust port 14, based on direction or rotation of the horsepower accelerator wheel 3. The exhaust tube 15 can use the vacuum generated by the exhaust port 14 to assist the exhaust tube 15 in pulling air from the backside of each blade 2 and 5.

As shown in FIGS. 1, 2, and 3, stationary magnets 17 and 18 can be located outside of the circumference of the horsepower accelerator wheel 3. The stationary magnets 17 and 18 can be ceramic, earth, electromagnets, or any other type of magnet known in the art. In one exemplary embodiment earth magnets are used as stationary magnets 17 and 18 based on their ability to maintain magnetic permeability for a longer period of time than ceramic magnets. The stationary magnets 17 and 18 typically have a stronger magnetic force than the rotational magnets 4. While two stationary magnets 17 and 18 are shown in FIG. 3, those skilled in the art will understand that the actual number of stationary magnets 17 and 18 can be more or less based on factors such as the spacing between rotational magnets 4, the circumference of the horsepower accelerator wheel 3, and the strength of the stationary magnets 17 and 18. In one exemplary embodiment, all stationary magnets 17 and 18 have the same polarity. The stationary 17 and 18 magnets can have a north or south polarity, and the rotation of the wheel 3 can be reversed by changing the polarity of the stationary magnets 17 and 18. The stationary magnets 17 and 18 are positioned above the circumference of the horsepower accelerator wheel 3 so that when stationary magnet 17 is creating a magnetic pull with the rotational magnet 4 closest to stationary magnet 17, stationary magnet 18 is creating a magnetic push with the rotational magnet closest to stationary magnet 18. The stationary magnets 17 and 18 are typically positioned within one-inch of the circumference of the horsepower accelerator wheel 3 and, as shown in FIG. 2, are typically as long as the rotational magnets 4.

As shown in FIG. 3, the stationary magnets 17 and 18 can be mounted in a cradle 36, inside the covers 8 and 13 and just outside the circumference of the horsepower accelerator wheel 3. The cradle 36 is orthogonally attached to vertical adjustment screws 34. The vertical adjustment screws are threaded through a steel threaded plate 33, which can be mounted to the exterior of the covers 8 and 13. In one exemplary embodiment, a gasket 35 of neoprene or other like material is positioned between the steel threaded plate 33 and the cover 8 or 13 to reduce air lost inside the covers 8 and 13. The steel threaded plate 33 can be attached to the covers 8 and 13 with fasteners, such as nuts, bolts, or screws, or can be welded, riveted, or attached using any other attachment method known in the art (not shown). The cradle 36 can also be attached to horizontal adjustment screws (not shown). The horizontal adjustment screws can be threaded through a horizontal threaded plate (not shown). The horizontal threaded plate can be located outside of and attached to the cover 8 or 13 with fasteners, such as nuts, bolts, or screws, or can be welded, riveted, or attached using any other attachment method known in the art (not shown). A gasket (not shown) of neoprene or other like material can be positioned between the horizontal threaded plate (not shown) and the cover 8 or 13 to reduce air lost inside the covers 8 and 13.

The cradle 36 typically comprises rubber, however other materials having low or no magnetic permeability could also be used. The cradle 36 can be adjusted in the vertical direction using the vertical adjustment screws 34 to move the stationary magnets 17 and 18 closer to or further away from the circumference of the horsepower accelerator wheel 3. The horizontal adjustment screws (not shown) can be adjusted to move the stationary magnets 17 and 18 in or against the direction of rotation. The adjustment of the position of the stationary magnets 17 and 18 increases the efficiency and starting capability of the horsepower accelerator wheel 3.

Returning to FIGS. 1 and 2, as the drive shaft 27 exits the horsepower accelerator wheel 3 opposite the motor 1, the drive shaft 27 is attached to the alternator 6. In one exemplary embodiment the alternator 6 is attached to drive shaft 27 through the use of a spider coupling (not shown), however one of ordinary skill in the art would realize that other methods of attachment, such as welding would be equally satisfactory. Through the rotation of the horsepower accelerator wheel 3 and the drive shaft 27, the alternator 6 generates electrical power to power the blowers 9, 10, 11, and 12, the motor 1, and additional applications needing electrical power, such as a house or the cabs of commercial vehicles. The alternator 6 can be single-phase, three-phase or European. Exemplary alternators 6 can be used to generate amounts of electricity having a range in excess of 5,000 to 400,000 watts. In one exemplary embodiment, a single-phase, 12 kilowatt alternator 6 is used in the generator system 100.

The alternator 6 can be attached to a mounting platform 22 with fasteners, such as nuts, bolts, or screws, or can be welded, riveted, or attached using any other attachment method known in the art (not shown). The mounting platform 22 can comprise a table or any other stationary surface that allows a shaft of the alternator 6 (not shown) to be substantially parallel with the drive shaft 27. The alternator 6 can be electrically coupled to a voltmeter 39. The voltmeter 39 typically displays the amount of electrical voltage being generated by the alternator 6. In one exemplary embodiment, the voltmeter 39 is electrically coupled to the alternator 6 via three-phase wire encased in conduit 40.

The alternator 6 is electrically coupled to a breaker box 7. The breaker box 7 can be attached to any surface with fasteners, such as nuts, bolts, or screws, or can be welded, riveted, or attached using any other attachment method known in the art (not shown). The breaker box 7 typically comprises a main breaker (not shown), a load box (not shown), and one or more semi-conductors (not shown). In one exemplary embodiment, the alternator 6 is electrically coupled to a breaker box 7 via three-phase wire encased in conduit 24.

The breaker box 7 is electrically coupled to the blowers 9, 10, 11, and 12 (coupling not shown) and the magnetic switch box 16 (coupling not shown). In one exemplary embodiment, the breaker box 7 is electrically coupled to the blowers 9, 10, 11, and 12 and the magnetic switch box 16 with three-phase wiring encased in electrical conduit (not shown). The breaker box provides electrical power generated by the alternator for blowers 9, 10, 11, and 12 and the motor 1. The magnetic switch box 16 typically comprises one or more magnetic switches and capacitors to assist in starting the motor 1. In one exemplary embodiment, the magnetic switch box 16 is electrically coupled to the motor 1 via three-phase wire encased in conduit 23.

It will be understood by those or ordinary skill in the art that while the exemplary embodiments have shown a generator system 100 wherein the horsepower accelerator wheel 3 rotates in the vertical direction, it is well within the purview of this invention to make minor modifications so that the horsepower accelerator wheel 3 could rotate in the horizontal or any other direction based on needs of the user and space available.

In one exemplary embodiment, a method of generating power using the generator system 100 typically begins by adjusting the horizontal (not shown) and vertical adjustment screws 34 to position the stationary magnets 17 and 18 in such a way that the horsepower accelerator wheel 3 begins to rotate. The horsepower accelerator wheel 3 typically begins to rotate when the stationary magnets are moved closer to the circumference of the wheel 3. The rotation of the horsepower accelerator wheel 3 turns the drive shaft 27, which turns the shaft on the alternator 6 generating a minimum level of electricity. Once a minimum level of electricity is being generated by use of magnets alone, a circuit breaker (not shown) for one of the blowers 9, 10, 11, and 12 at the breaker box 7 can be closed, allowing the electricity generated by the alternator 6 to be sent through the breaker box 7 to one of the blowers 9, 10, 11, or 12. In one exemplary embodiment, once the voltmeter 39 displays a reading of approximately 80 volts, the first circuit breaker is closed. Electrical power to the blower motor 30 generates high velocity air which is pushed through the blower vent 31 to drive the right-side or left side turbine fan blades 2 or 5. The air being released against the blades 2 or 5 increases the speed of the horsepower accelerator wheel 3, which in turn increases the rpm's of the drive shaft 27 and the total electricity generated by the alternator 6. A second circuit breaker for the blowers 9, 10, 11, and 12 at the breaker box 7 can be closed allowing the excess electricity to pass from the alternator 6 through the breaker box 7 to another blower 9, 10, 11, or 12 that is not yet receiving electrical power. By adding electrical power to another blower 9, 10, 11, or 12, additional force is placed against the turbine fan blades 2 and 5 and the speed of the horsepower accelerator wheel 3 increases. The increase in speed of the horsepower accelerator wheel 3 increases the rpm's of the drive shaft 27, thereby increasing the amount of electricity generated by the alternator 6. The circular process continues until enough electricity is generated by the alternator 6 to power all of the blowers 9, 10, 11, and 12. Once all of the blowers 9, 10, 11, and 12 are receiving electricity, a circuit breaker (not shown) for the motor 1 at the breaker box 7 can be closed, allowing excess electricity from the alternator 6 to pass through the breaker box 7 to the motor 1. The motor 1 can be used for load balancing. In one exemplary embodiment, the horsepower of the motor 1 is substantially equal to eighteen percent of load. In alternative embodiments, the circuit breaker for the motor 1 can be closed before any of the circuit breakers for the blowers 9, 10, 11, and 12, or after one or more circuit breakers for the blowers 9, 10, 11, and 12 have been closed. Once all blowers 9, 10, 11, and 12 and the motor 1 are receiving electricity, a circuit breaker (not shown) can be closed at the breaker box 7 allowing excess electricity, generated by the alternator 6, to be passed through the breaker box 7 to external systems as a power source. In one exemplary embodiment, the circuit breakers can be closed and opened manually. In another exemplary embodiment, the passing of electricity to the blowers 9, 10, 11, and 12, the motor 1, and to external systems can be controlled by a programmable logic controller of other control devices known the those of ordinary skill in the art. In one exemplary embodiment, the generator system 100 uses less than thirty percent of the generating head, allowing over seventy percent of the electricity generated by the generator system 100 to be used for external power needs.

In conclusion, the present invention comprises a completely self-contained power generating system 100. The invention allows for the generation of excess electrical power through the use of a horsepower accelerator wheel 3, a system of blowers 9, 10, 11, and 12, stationary magnets 17 and 18, rotational magnets 4, and an alternator 6. The excess electricity generated by the generator system 100 can then be passed to external systems requiring electrical power without the need for fossil fuels or nuclear waste from fission reactors.

It will be appreciated that the present invention fulfills the needs of the prior art described herein and meets the above-stated objectives. While there have been shown and described several exemplary embodiments of the present invention, it will be evident to those skilled in the art that various modifications and changes may be made thereto without departing from the spirit and the scope of the present invention as set forth in the appended claims and equivalence thereof.

What is claimed is:

1. A horsepower accelerator wheel comprising:
a first rotor plate and a second rotor plate mounted for axial rotation;
a plurality of magnet mounts coupled to an inside plane of the first and second rotor plates;
a plurality of rotational magnets coupled to the plurality of magnet mounts;
a plurality of right-side turbine blades coupled to an outside plane of the first rotor plate;
a plurality of stationary magnets positioned outside a circumference of the first and second rotor plates and capable of providing a magnetic pull and a magnetic push on the rotational magnets; and
a first blower coupled to a mounting bracket for generating air pressure against the right-side turbine blades.

2. The horsepower accelerator wheel of claim 1, further comprising:
a plurality of left-side turbine blades coupled to an outside plane of the second rotor plate and
a second blower coupled to a mounting bracket for generating air pressure against the left-side turbine blades.

3. The horsepower accelerator wheel of claim 1, wherein:
a leading edge of the rotational magnets has a first polarity;
a trailing edge of the rotational magnets has a second polarity; and
the stationary magnets have a second polarity.

4. The horsepower accelerator wheel of claim 1, further comprising a cover coupled to a first mounting bracket, wherein the cover substantially encloses the horsepower accelerator wheel.

5. The horsepower accelerator wheel of claim 4, further comprising an exhaust port coupled to the cover, wherein the exhaust port removes air generated by the first blower from the horsepower accelerator wheel.

6. The horsepower accelerator wheel of claim 5, further comprising an exhaust tube having a first end coupled to the cover and a second end coupled to the exhaust port, wherein the exhaust tube removes air from the horsepower accelerator wheel and passes the air through the exhaust port.

7. The horsepower accelerator wheel of claim 4, further comprising:
a cradle for holding one of the stationary magnets;
a vertical adjustment plate coupled to the cover; and
a vertical adjustment device having a first end coupled to the cradle and a second end passing through the vertical adjustment plate, wherein the vertical adjustment device is capable of moving one of the stationary magnets in a direction nearer to or farther from the a center-point of the horsepower accelerator wheel.

8. The horsepower accelerator wheel of claim 4, further comprising:
a cradle for holding one of the stationary magnets;
a horizontal adjustment plate coupled to the cover; and
a horizontal adjustment device having a first end coupled to the cradle and a second end passing through the vertical adjustment plate, wherein the horizontal adjustment device is capable of moving one of the stationary magnets in a direction along a tangent of a radius of the horsepower accelerator wheel.

9. An electrical generating system comprising:
a horsepower accelerator wheel coupled to a drive shaft for axial rotation, wherein the horsepower accelerator wheel is capable of generating rotational energy;
an alternator coupled to a first end of the drive shaft and capable of converting the rotational energy of the drive shaft into electrical energy; and
a breaker box electrically coupled to the alternator and the plurality of blowers, wherein the breaker box is capable or receiving electrical energy generated by the alternator and transmitting it outside of the system and wherein the breaker box comprises:
a main breaker;
a load box; and
a plurality of semi-conductors.

10. The system of claim 9, further comprising a motor coupled to a second end of the drive shaft and electrically coupled to the breaker box, wherein the motor operates as a load balance for the alternator.

11. The system of claim 10, further comprising a magnetic switch box having a first end electrically coupled to the breaker box and a second end electrically coupled to the motor, wherein the magnetic switch box comprises the capability to start the motor.

12. The system of claim 9, wherein the horsepower accelerator wheel comprises:
a first rotor plate and a second rotor plate mounted for axial rotation;
a plurality of magnet mounts coupled to an inside plane of the first and second rotor plates;
a plurality of rotational magnets coupled to the plurality of magnet mounts, wherein each rotational magnet comprises a leading edge having a first polarity and a trailing edge having a second polarity;
a plurality of right-side turbine blades coupled to an outside plane of the first rotor plate;
a plurality of left-side turbine blades coupled to an outside plane of the second rotor plate;
a first blower coupled to a first mounting bracket for generating air pressure against the right-side turbine blades;
a second blower coupled to a second mounting bracket for generating air pressure against the left-side turbine blades; and
a plurality of stationary magnets having a second polarity, wherein the stationary magnets are positioned outside a circumference of the first and second rotor plates and capable of providing a magnetic pull and a magnetic push on the rotational magnets.

13. The system of claim 12 further comprising:
a cover coupled to a first mounting bracket, wherein the cover substantially encloses the horsepower accelerator wheel;
an exhaust port coupled to the cover; and
an exhaust tube having a first end coupled to the cover and a second end coupled to the exhaust port.

14. The system of claim 13, wherein the cover comprises the first mounting bracket coupled to the first blower and the second mounting bracket coupled to the second blower.

15. The system of claim 9, further comprising a voltmeter electrically coupled to the alternator for generating a display of the electrical voltage generated by the alternator.

16. A method of generating electricity with a horsepower accelerator wheel comprising the steps of:
positioning at least one stationary magnet having a first polarity along a point outside of the circumference of the horsepower accelerator wheel to induce rotation of the horsepower accelerator wheel, wherein the horsepower accelerator wheel comprises a plurality of first-side turbine blades and a plurality of second-side turbine blades;
generating an first electrical current by transferring a rotational energy generated by the horsepower accelerator wheel to an alternator;
transmitting at least a portion of the first electrical current to operate a first blower for generating air pressure against the first-side turbine blades;
generating a second electrical current having a voltage greater than the voltage of the first electrical current;
transmitting at least a portion of the second electrical current to operate a second blower for generating air pressure against the second-side turbine blades;
generating a third electrical current having a voltage greater than the second electrical current; and
transmitting an excess electrical current to an external power consumer.

17. The method of claim 16, further comprising transmitting at least a portion of the third electrical current to operate a motor coupled to the accelerator and the horsepower accelerator wheel, wherein the motor balances an electrical load.

18. The method of claim 16, wherein the horsepower accelerator wheel further comprises:
a first rotor plate and a second rotor plate mounted to a shaft for axial rotation;
a plurality of magnet mounts coupled to an inside plane of the first and second rotor plates;
plurality of rotational magnets coupled to the plurality of magnet mounts, wherein each rotational magnet comprises a leading edge having a first polarity and a trailing edge having a second polarity;
first blower coupled to a first mounting bracket;
second blower coupled to a second mounting bracket; and
a plurality of stationary magnets having a second polarity, wherein the stationary magnets are positioned outside a circumference of the first and second rotor plates and capable of providing a magnetic pull and a magnetic push on the rotational magnets.
